(19) United States
(12) Patent Application Publication
(10) Pub. No.: US 2018/0288289 A1
(43) Pub. Date: Oct. 4, 2018

(54) IMAGE CAPTURING MODULE WITH A PRIVACY PROTECTION FUNCTION AND ELECTRONIC DEVICE THEREWITH

(71) Applicants: IEI Integration Corp., New Taipei City (TW); Armorlink SH Corp., Shang-Hai City (CN)

(72) Inventors: Yu-Tsung Chang, New Taipei City (TW); Tzu-Wei Fu, New Taipei City (TW)

(21) Appl. No.: 15/479,262

(22) Filed: Apr. 4, 2017

(51) Int. Cl. H04N 5/225; H04N 5/232; F16M 11/18; F16M 11/10

(52) U.S. Cl. CPC H04N 5/2251; F16M 11/10; F16M 11/18; H04N 5/23241

(57) ABSTRACT

An image capturing module includes an image capturing device, a driven component, a pivoting mechanism, a sensing device, and a control unit. The pivoting mechanism is connected to the image capturing device and movably connected to the driven component. The pivoting mechanism is for driving the image capturing device to rotate to a first position and further for driving the driven component to rotate to a first limiting position when the pivoting mechanism drives the image capturing device to rotate to the first position. The sensing device is for sensing whether the driven component is located at the first limiting position. The control unit is electrically connected to the sensing device and the image capturing device for powering on or powering off the image capturing according to a sensing result of sensing whether the driven component is located at the first limiting position by the sensing device.

### BACKGROUND OF THE INVENTION

### 1. Field of the Invention

The present invention relates to an image capturing module, and more particularly, to an image capturing module with a privacy protection function and an electronic device therewith.

### 2. Description of the Prior Art

With advance of technology, an electronic device usually includes an image capturing module to meet different users' needs, such as for videoconference, remote patient monitor, and etc. The conventional image capturing module is powered on or powered off by a physical button or a visual icon of software application. However, a camera of the image capturing module still faces a user even if the image capturing module is powered off. It is not easy for the user to figure out whether the image capturing module is powered off correctly or not, which results in privacy concerns.

### SUMMARY OF THE INVENTION

Therefore, it is an objective of the present invention to provide an image capturing module with a privacy protection function and an electronic device therewith for solving the aforementioned problems.

In order to achieve aforementioned objective, the present invention discloses an image capturing module including an image capturing device, a driven component, a pivoting mechanism, a sensing device, and a control unit. The image capturing device is for capturing images. The pivoting mechanism is connected to the image capturing device and movably connected to the driven component. The pivoting mechanism is for driving the image capturing device to rotate to a first position and further for driving the driven component to move to a first limiting position when the pivoting mechanism drives the image capturing device to rotate to the first position. The sensing device is for sensing whether the driven component is located at the first limiting position. The control unit is electrically connected to the sensing device and the image capturing device. The control unit is for powering on or powering off the image capturing device according to a sensing result of sensing whether the driven component is located at the first limiting position by the sensing device.

According to an embodiment of the present invention, the control unit powers off the image capturing device when the sensing device senses the driven component is located at the first limiting position.

According to an embodiment of the present invention, the pivoting mechanism is further for driving the image capturing device to rotate between the first position and a second position, and the pivoting mechanism is further for driving the driven component to move to a second limiting position when the pivoting mechanism drives the image capturing device to rotate to the second position.

According to an embodiment of the present invention, the control unit further powers off the image capturing device when the sensing device senses the driven component is located at the second limiting position.

According to an embodiment of the present invention, the image capturing module further includes an actuating device electrically connected to the control unit and connected to the pivoting mechanism for driving the pivoting mechanism to rotate.

According to an embodiment of the present invention, the actuating device includes a pulley and a motor. The pulley is connected to the pivoting mechanism. The motor is connected to the pulley and for driving the pulley to rotate the pivoting mechanism.

According to an embodiment of the present invention, the sensing device is a light sensor or a proximity sensor.

According to an embodiment of the present invention, the pivoting mechanism includes a pivoting shaft, a first rib, and a second rib. The first rib and the second rib protrude from the pivoting shaft separately and are spaced from each other. A connecting portion is formed between the first rib and the second rib. The driven component is a cam component. The cam component movably inserts into the connecting portion and selectively abuts against the first rib or the second rib, and the first rib pushes the driven component to move toward the first limiting position when the pivoting mechanism drives the image capturing device to rotate toward the first position along a first rotating direction.

According to an embodiment of the present invention, the second rib pushes the driven component to move away from the first limiting position when the pivoting mechanism drives the image capturing device to rotate away from the first position along a second rotating direction opposite to the first rotating direction.

In order to achieve aforementioned objective, the present invention further discloses an electronic device including a casing, an image capturing module, and an input module. The image capturing module is installed on the casing in a rotatable manner. The image capturing module includes an image capturing device, a driven component, a pivoting mechanism, a sensing device, and a control unit. The image capturing device is for capturing images. The pivoting mechanism is connected to the image capturing device and movably connected to the driven component. The pivoting mechanism is for driving the image capturing device to rotate to a first position and further for driving the driven component to move to a first limiting position when the pivoting mechanism drives the image capturing device to rotate to the first position. The sensing device is for sensing whether the driven component is located at the first limiting position. The control unit is electrically connected to the sensing device and the image capturing device. The control unit is for powering on or powering off the image capturing device according to a sensing result of sensing whether the driven component is located at the first limiting position by the sensing device. The input module is electrically connected to the control unit for inputting commands to control the control unit to operate the image capturing device.

In summary, the image capturing module of the present invention utilizes the pivoting mechanism for driving the driven component to move to the first limiting position when the image capturing device is driven by the pivoting mechanism to the first position, so that the control unit can power on or power off the image capturing device according to the sensing result of sensing whether the driven component is located at the first limiting position by the sensing device. In such a way, when it is desired to power off the image capturing device, the image capturing device is driven by the pivoting mechanism to face toward a direction other than a user, such as an upward direction, which ensures that the image capturing device cannot capture the user's image even if the image capturing device is not powered off correctly. Therefore, the present invention can reduce a risk of privacy leakage and eliminate users' concerns.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is a partial exploded diagram of the electronic device according to the embodiment of the present invention.

FIG. 3 is a functional block diagram of the electronic device according to the embodiment of the present invention.

FIG. 4 is a diagram of a pivoting mechanism and a driven component according to the embodiment of the present invention.

FIG. 5 is a diagram of an image capturing device located at a first position according to the embodiment of the present invention.

FIG. 6 is a diagram of the image capturing device located at a second position according to the embodiment of the present invention.

FIG. 7 is a diagram of the pivoting mechanism and the driven component as the image capturing device is located at the first position according to the embodiment of the present invention.

FIG. 8 is a diagram of the pivoting mechanism and the driven component as the image capturing device is located at the second position according to the embodiment of the present invention.

### DETAILED DESCRIPTION

In order to illustrate technical specifications and structural features as well as achieved purposes and effects of the present invention, relevant embodiments and figures are described as follows.

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

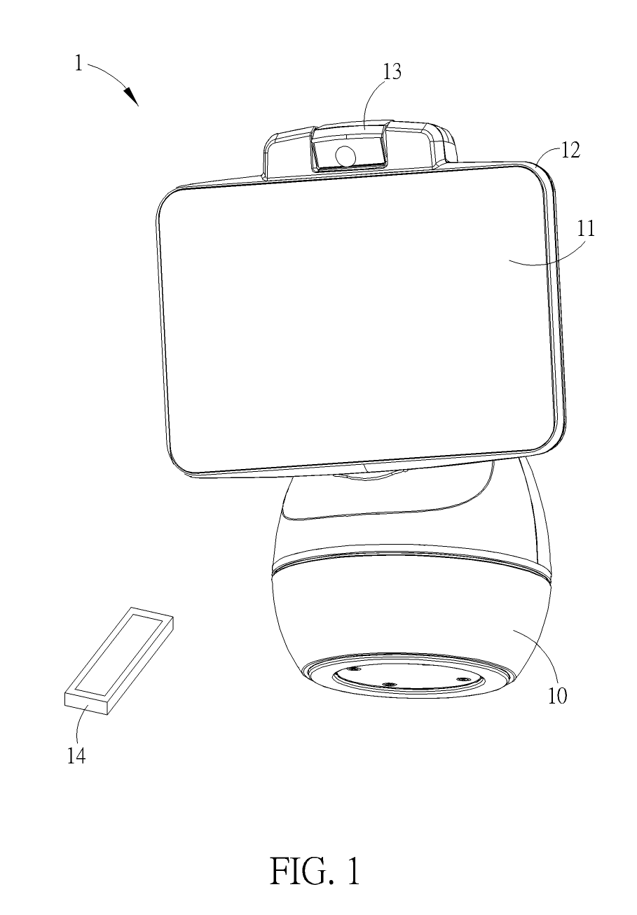

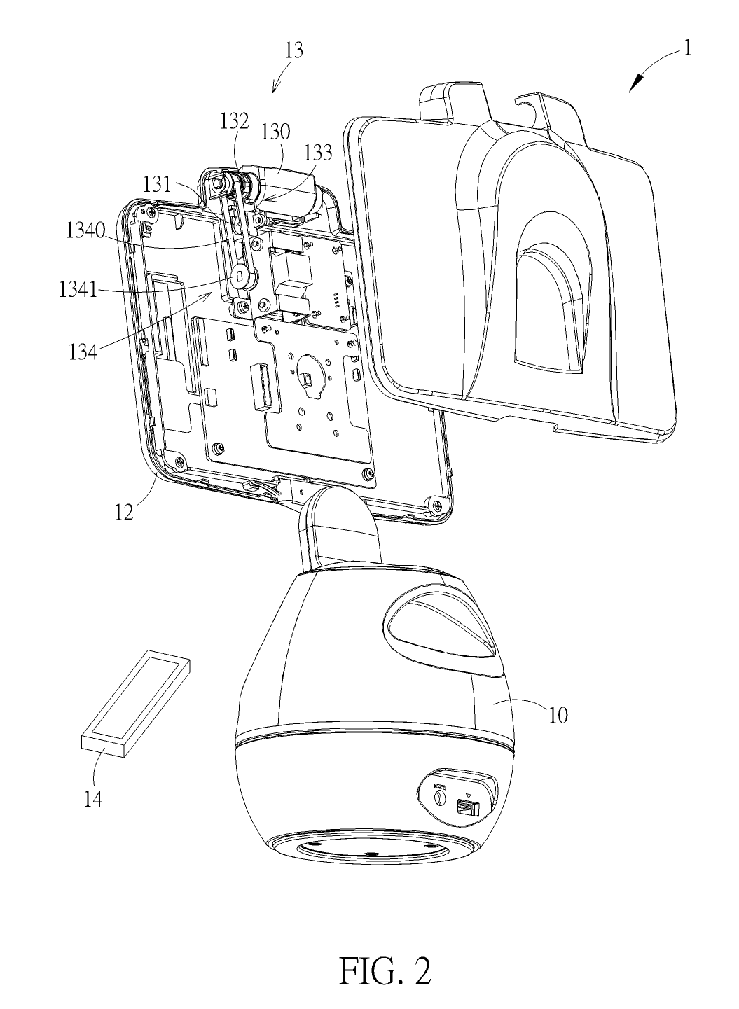

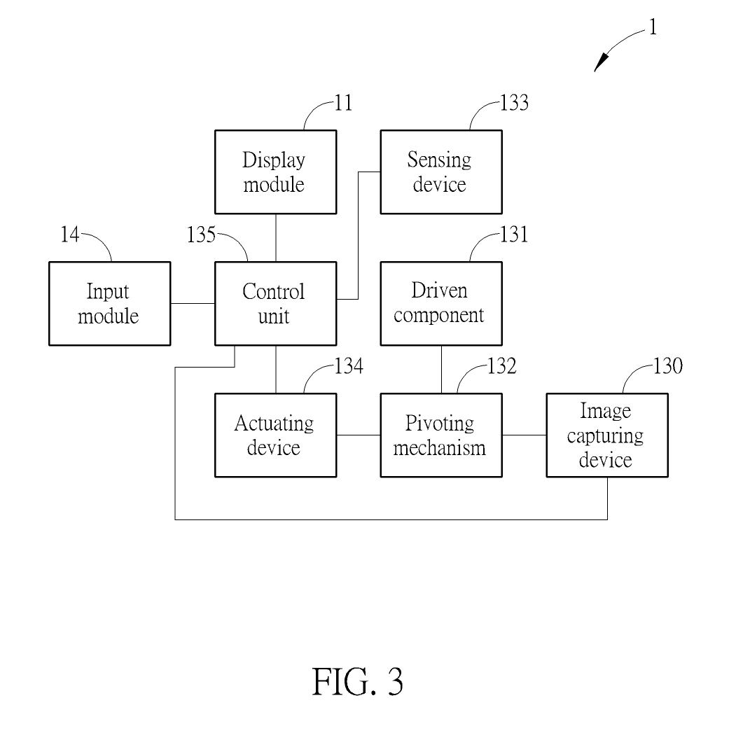

Please refer to FIG. 1 to FIG. 3. FIG. 1 is a schematic diagram of an electronic device 1 according to an embodiment of the present invention. FIG. 2 is a partial exploded diagram of the electronic device 1 according to the embodiment of the present invention. FIG. 3 is a functional block diagram of the electronic device 1 according to the embodiment of the present invention. As shown in FIG. 1 to FIG. 3, the electronic device 1 includes a base 10, a display module 11, a casing 12, an image capturing module 13, and an input module 14. The casing 12 is pivoted to the base 10. The display module 11 is installed on a side of the casing 12. The image capturing module 13 is installed on the casing 12 in a rotatable manner. The image capturing module 13 includes an image capturing device 130, a driven component 131, a pivoting mechanism 132, a sensing device 133, an actuating device 134, and a control unit 135. The image capturing device 130 is for capturing images. The pivoting mechanism 132 is connected to the image capturing device 130 and movably connected to the driven component 131. The pivoting mechanism 132 is for driving the image capturing device 130 to rotate and further for driving the driven component 131 to move during the period that the pivoting mechanism 132 drives the image capturing device 130 to rotate. The sensing device 133 is for sensing a position of the driven component 131. The actuating device 134 is connected to the pivoting mechanism 132. The control unit 135 is electrically connected to the display module 11, the actuating device 134, the sensing device 133, the image capturing device 130, and the input module 14. The control unit 135 is for controlling the actuating device 134 to drive the pivoting mechanism 132 and further for powering on or powering off the image capturing device 130 according to a sensing result of sensing the position of the driven component 131 by the sensing device 133. The input module 14 is for inputting commands to control the control unit 135 to operate the image capturing device 130. In this embodiment, the electronic device 1 can be a video conferencing apparatus or a remote patient monitoring apparatus. The image capturing device 130 can be a web camera. The input module 14 can be a keyboard module, a remote controller module, or a touch module. The sensing device 133 can be a proximity sensor or a light sensor. However, the present invention is not limited to this embodiment.

However, it is not necessary for users to utilize the input module 14 for controlling the control unit 135 to operate the image capturing device 130. For example, in another embodiment, the input module 14 and the actuating device 134 can be omitted. In other words, users can rotate the image capturing device 130 manually to drive the pivoting mechanism 132 to move the driven component 131.

As shown in FIG. 2, the actuating device 134 includes a pulley 1340 and a motor 1341. The pulley 1340 is connected to the pivoting mechanism 132. The motor 1341 is connected to the pulley 1340 and for driving the pulley 1340 to rotate the pivoting mechanism 132. However, structure and configuration of the actuating mechanism 134 of the present invention are not limited to those illustrated in this embodiment. For example, in another embodiment, the actuating device 134 also can include the motor 1341 and a gear reducer. In other words, mechanisms or structures which can drive the pivoting mechanism 132 are within the scope of the present invention.

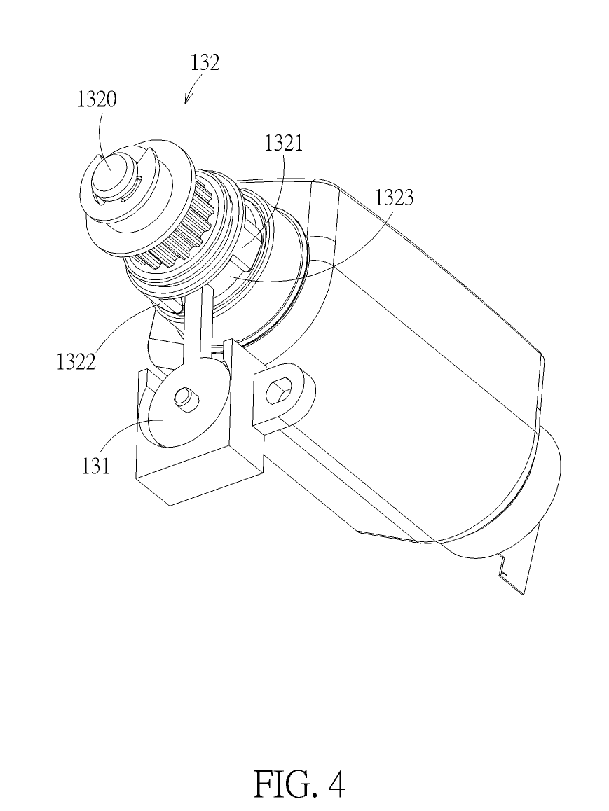

Please refer to FIG. 4. FIG. 4 is a diagram of the pivoting mechanism 132 and the driven component 131 according to the embodiment of the present invention. As shown in FIG. 4, the pivoting mechanism 132 includes a pivoting shaft 1320, a first rib 1321, and a second rib 1322. The first rib 1321 and the second rib 1322 protrude from the pivoting shaft 1320 and are spaced from each other. A connecting portion 1323 is formed between the first rib 1321 and the second rib 1322. The driven component 131 movably inserts into the connecting portion 1323, so that the pivoting mechanism 132 can drive the driven component 131 to move by cooperation of the first rib 1321, the second rib 1322, the connecting portion 1323, and the driven component 131 when the pivoting mechanism 132 drives the image capturing device 130 to rotate. Furthermore, in this embodiment, the driven component 131 can be preferably a cam component.

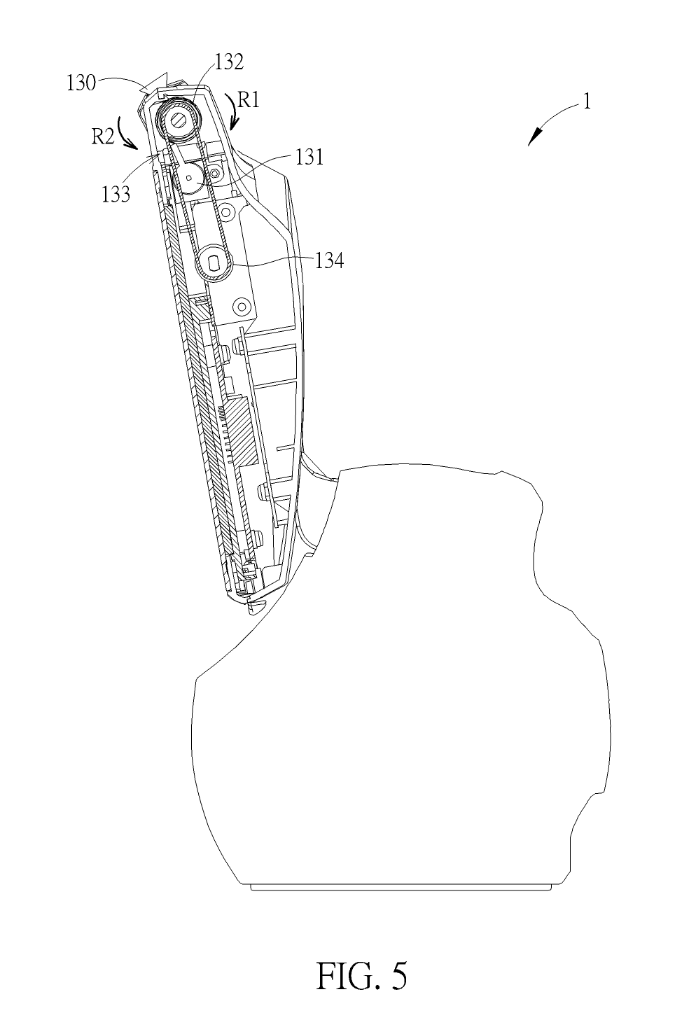

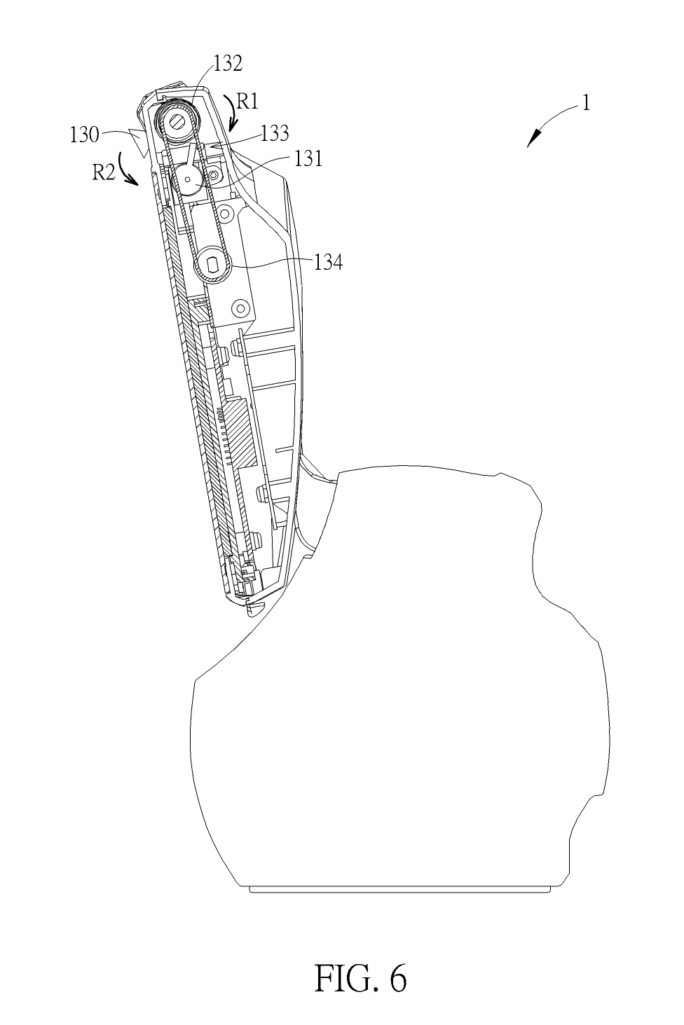

Please refer to FIG. 1 to FIG. 6. FIG. 5 is a diagram of the image capturing device 130 located at a first position according to the embodiment of the present invention. FIG. 6 is a diagram of the image capturing device 130 located at a second position according to the embodiment of the present invention. As shown in FIG. 5, when users input commands via the input module 14 for controlling the control unit 135 to operate the actuating device 134 to drive the pivoting mechanism 132 to rotate the image capturing device 130 to the first position along a first rotating direction R1, the pivoting mechanism 132 drives the driven component 131 to move to a first limiting position. When the sensing device 133 senses that the driven component 131 is located at the first limiting position, the sensing device 133 outputs a corresponding sensing signal to the control unit 135 to power off the image capturing device 130.

Specifically, in the case of that the sensing device 133 is the proximity sensor, the proximity sensor can output a sensing signal to the control unit 135 for powering off the image capturing device 130 when the driven component 131 move to a position close enough to the proximity sensor, i.e., when the driven component 131 is located at the first limiting position. In the case of that the sensing device 133 is the light sensor including a light emitting component and a light receiving component for receiving light emitted from the light emitting component, the light emitting component and the light receiving component can be disposed on two opposite sides of the driven component 131, so that the driven component 131 can block the light emitted from the light emitting component when the driven component 131 is located at the first limiting position. Since the light receiving component cannot receive the light emitted from the light emitting component when the driven component 131 is located at the first limiting position, the light sensor outputs a blocking signal to the control unit 135 for powering off the image capturing device 130. Alternatively, the light emitting component and the light receiving component also can be disposed on the same side of the driven component 131. When the driven component 131 is located at the first limiting position, the driven component 131 can be configured to reflect the light emitted from the light emitting component to the light receiving component. Since the light receiving component can receive the light emitted from the light emitting component and reflected by the driven component 131 when the driven component 131 is located at the first limiting position, the light sensor outputs a reflecting signal to the control unit 135 for powering off the image capturing device 130. Furthermore, in this embodiment, when the image capturing device 130 is powered off, the image capturing device 130 is driven to be located at the first position. That is, the image capturing device 130 can face upwardly, as shown in FIG. 5, instead of facing users. Therefore, it reduces a risk of privacy leakage and eliminates users' concerns.

On the other hand, when users input commands via the input module 14 to control the control unit 135 to operate the actuating device 134 to drive the pivoting mechanism 132 to rotate the image capturing device 130 from the first position, as shown in FIG. 5, to the second position, as shown in FIG. 6, along a second rotating direction R2 opposite to the first rotating direction R1, the pivoting mechanism 132 can drive the driven component 131 to move from the first limiting position, as shown in FIG. 5, to a second limiting position, as shown in FIG. 6. During the aforementioned process, the sensing device 133 outputs a corresponding signal to the control unit 135 for powering on the image capturing device 130 once the sensing device 133 senses that the driven component 131 departs from the first limiting position.

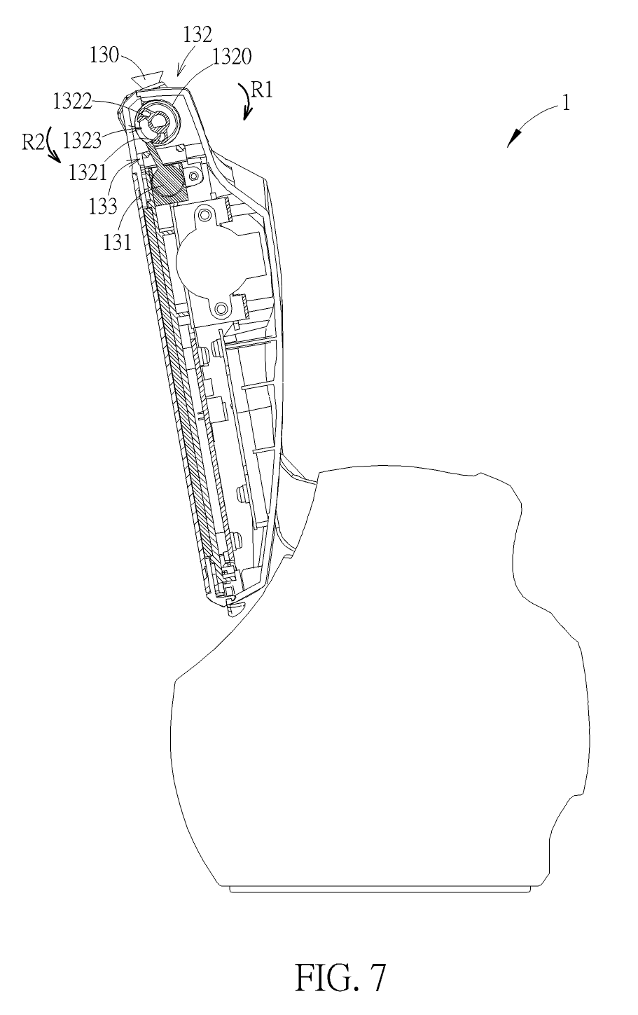

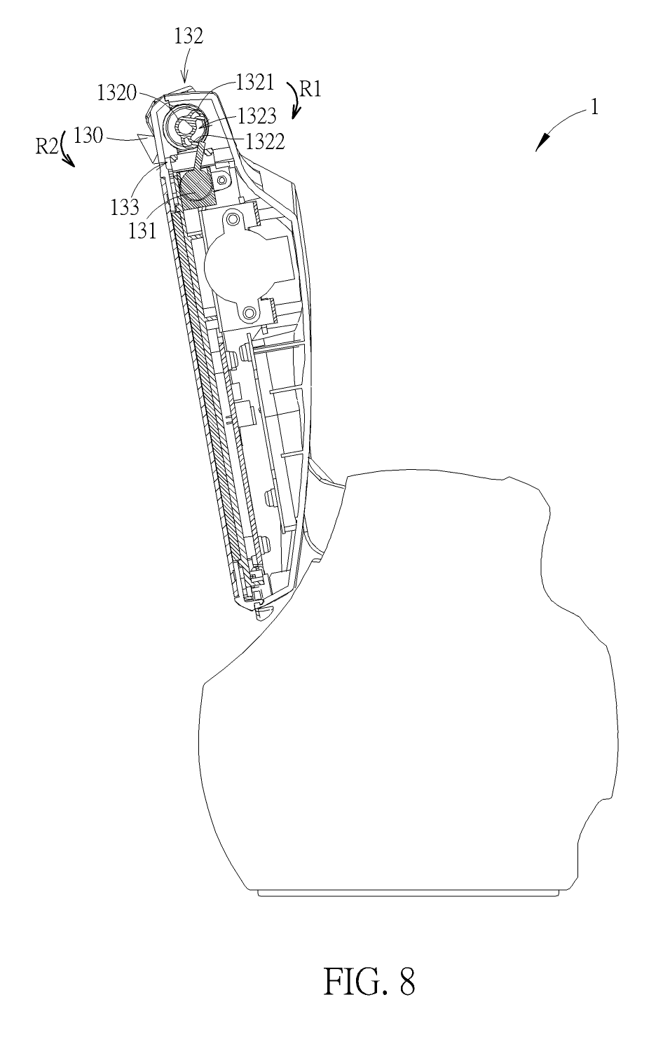

Specifically, when the pivoting mechanism 132 drives the image capturing device 130 to rotate toward the first position along the first rotating direction R1, the pivoting mechanism 132 pushes the driven component 131 to move toward the first limiting position by the first rib 1321. On the other hand, when the pivoting mechanism 132 drives the image capturing device 130 to rotate away from the first position along the second rotating direction R2, the pivoting mechanism pushes the driven component 131 to move away from the first limiting position by the second rib 1322. Please refer to FIG. 7 and FIG. 8. FIG. 7 is a diagram of the pivoting mechanism 132 and the driven component 131 as the image capturing device 130 is located at the first position according to the embodiment of the present invention. FIG. 8 is a diagram of the pivoting mechanism 132 and the driven component 131 as the image capturing device 130 is located at the second position according to the embodiment of the present invention. As shown in FIGS. 7 and 8, the first rib 1321 and the second rib 1322 are spaced from each other and disposed at an included angle. Therefore, after the image capturing device 130 is driven to rotate to the first position by the pivoting mechanism 132, it has to rotate the image capturing device 130 reversely from the first position by a predetermined angle along the second rotating direction R2 to drive the second rib 1322 to abut against the driven component 131 for driving the driven component 131 to leave away from the first limiting position. Therefore, the present invention prevents the image capturing device 130 from being powered on when the image capturing device 130 departs from the first position due to operational mistake of the input module 14 or the image capturing device 130. That is, such structure design provides a buffering space for powering on the image capturing device 130.

Furthermore, the buffering space, i.e., the predetermined angle from the first position, of the present invention can be determined by the included angle between the first rib 1321 and the second rib 1322, i.e., a distance between the first rib 1321 and the second rib 1322. In other words, when the included angle between the first rib 1321 and the second rib 1322 gets smaller, i.e., when the first rib 1321 and the second rib 1322 get closer to each other, the predetermined angle gets smaller. When the included angle between the first rib 1321 and the second rib 1322 gets greater, i.e., when the first rib 1321 and the second rib 1322 get farther from each other, the predetermined angle gets greater.

Besides, in this embodiment, the control unit 135 can further be configured to identify a user who logs in the electronic device 1 to provide a corresponding authorization of operation. For example, the authorization of operation can be divided into three categories including administrators, power users, and guests. Firstly, the administrators can be authorized to execute the following operations: 1. adjusting a position of the image capturing device 130, i.e., a swing angle of the image capturing device 130, by the input module 14; 2. powering off the image capturing device 130 by the input module 14; 3. powering on the image capturing device 130 by the input module 14. Secondly, the power users can be authorized to execute the following operations: 1. adjusting a position of the image capturing device 130, i.e., a swing angle of the image capturing device 130, by the input module 14; 2. powering off the image capturing device 130 by the input module 14; 3. powering on the image capturing device 130 which has been powered off previously by himself/herself by the input module 14. Thirdly, the guests can be authorized to adjust a position of the image capturing device 130 only. However, it is not limited thereto. It depends on practical demands.

When a user, who is identified as the administrator, inputs commands via the input module 14 to control the control unit 135 to drive the image capturing device 130 and the driven component 131, the control unit 135 can power on or power off the image capturing device 10 according to the sensing result of the sensing device 133, as mentioned above. When a user, who is identified as the power user, the power user is authorized to input commands via the input module 14 to execute operations of adjusting a position of the image capturing device 130, i.e., a swing angle of the image capturing device 130, by the input module 14, powering off the image capturing device 130 by the input module 14, and powering on the image capturing device 130 which has been powered off by himself/herself previously by the input module 14. In other words, for example, when the image capturing device 130 is powered off by the administrator or another power user, the control unit 135 will not power on the image capturing device 130 even if the sensing device 133 senses that the driven component 131 leaves away from the first limiting position in this situation. Similarly, for example, when a user is identified as the guest, the guest is only authorized to input commands via the input module 14 to adjust a position of the image capturing device 130. Therefore, no matter whether the driven component 131 is located at the first limiting position or not, the control unit 135 cannot power on or power off the image capturing device according to the sensing result of the sensing device 133 in this situation.

Furthermore, in another embodiment, the control unit 135 of the image capturing module 13 can further be configured to power off the image capturing device 130 when the sensing device 133 senses that the driven component 131 is located at the second limiting position. That is, the control unit 135 powers off the image capturing device 130 when the sensing device 133 senses that the driven component 131 is located at the first limiting position or the second limiting position. Furthermore, the image capturing device 130 faces upwardly when the driven component 131 is located at the first limiting position. The image capturing device 130 faces downwardly when the driven component 131 is located at the second limiting position. In such a way, the image capturing device 130 will not face a user directly when the image capturing device 130 is powered off. Therefore, it prevents a risk of privacy leakage and eliminates users' concerns. Furthermore, operation of the control unit 135 powering on and powering off the image capturing device 130 according to a sensing result of sensing whether the driven component 131 is located at the second limiting position is similar to the one illustrated in the aforementioned embodiment. Detailed description is omitted herein for simplicity.

In contrast to the prior art, the image capturing module of the present invention utilizes the pivoting mechanism for driving the driven component to move to the first limiting position when the image capturing device is driven by the pivoting mechanism to the first position, so that the control unit can power on or power off the image capturing device according to the sensing result of sensing whether the driven component is located at the first limiting position by the sensing device. In such a way, when it is desired to power off the image capturing device, the image capturing device is driven by the pivoting mechanism to face toward a direction other than a user, such as an upward direction, which ensures that the image capturing device cannot capture the user's images even if the image capturing device is not powered off correctly. Therefore, the present invention can reduce a risk of privacy leakage and eliminate users' concerns.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image capturing module comprising:
an image capturing device for capturing images;
a driven component;
a pivoting mechanism connected to the image capturing device and movably connected to the driven component, the pivoting mechanism being for driving the image capturing device to rotate to a first position, and the pivoting mechanism further being for driving the driven component to move to a first limiting position when the pivoting mechanism drives the image capturing device to rotate to the first position;
a sensing device for sensing whether the driven component is located at the first limiting position; and
a control unit electrically connected to the sensing device and the image capturing device, the control unit being for powering on or powering off the image capturing device according to a sensing result of sensing whether the driven component is located at the first limiting position by the sensing device.

2. The image capturing module of claim 1, wherein the control unit powers off the image capturing device when the sensing device senses the driven component is located at the first limiting position.

3. The image capturing module of claim 1, wherein the pivoting mechanism is further for driving the image capturing device to rotate between the first position and a second position, and the pivoting mechanism is further for driving the driven component to move to a second limiting position when the pivoting mechanism drives the image capturing device to rotate to the second position.

4. The image capturing module of claim 3, wherein the control unit further powers off the image capturing device when the sensing device senses the driven component is located at the second limiting position.

5. The image capturing module of claim 1, further comprising:
an actuating device electrically connected to the control unit and connected to the pivoting mechanism for driving the pivoting mechanism to rotate.

6. The image capturing module of claim 5, wherein the actuating device comprises:
a pulley connected to the pivoting mechanism; and
a motor connected to the pulley and for driving the pulley to rotate the pivoting mechanism.

7. The image capturing module of claim 1, wherein the sensing device is a light sensor or a proximity sensor.

8. The image capturing module of claim 1, wherein the pivoting mechanism comprises a pivoting shaft, a first rib and a second rib, the first rib and the second rib protrude from the pivoting shaft separately and are spaced from each other, a connecting portion is formed between the first rib and the second rib, the driven component is a cam component, the cam component movably inserts into the connecting portion and selectively abuts against the first rib or the second rib, and the first rib pushes the driven component to move toward the first limiting position when the pivoting mechanism drives the image capturing device to rotate toward the first position along a first rotating direction.

9. The image capturing module of claim 8, wherein the second rib pushes the driven component to move away from the first limiting position when the pivoting mechanism drives the image capturing device to rotate away from the first position along a second rotating direction opposite to the first rotating direction.

10. An electronic device comprising:
a casing;
an image capturing module installed on the casing in a rotatable manner, the image capturing module comprising:
an image capturing device for capturing images;
a driven component;
a pivoting mechanism connected to the image capturing device and movably connected to the driven component, the pivoting mechanism being for driving the image capturing device to rotate to a first position, and the pivoting mechanism further being for driving the driven component to move to a first limiting position when the pivoting mechanism drives the image capturing device to rotate to the first position;
a sensing device for sensing whether the driven component is located at the first limiting position; and
a control unit electrically connected to the sensing device and the image capturing device, the control unit being for powering on or powering off the image capturing device according to a sensing result of sensing whether the driven component is located at the first limiting position by the sensing device; and
an input module electrically connected to the control unit for inputting commands to control the control unit to operate the image capturing device.

11. The electronic device of claim 10, wherein the control unit powers off the image capturing device when the sensing device senses the driven component is located at the first limiting position.

12. The electronic device of claim 10, wherein the pivoting mechanism is further for driving the image capturing device to rotate between the first position and a second position, and the pivoting mechanism is further for driving the driven component to move to a second limiting position when the pivoting mechanism drives the image capturing device to rotate to the second position.

13. The electronic device of claim 12, wherein the control unit further powers off the image capturing device when the sensing device senses the driven component is located at the second limiting position.

14. The electronic device of claim 10, further comprising:
an actuating device electrically connected to the control unit and connected to the pivoting mechanism for driving the pivoting mechanism to rotate.

15. The electronic device of claim 14, wherein the actuating device comprises:
a pulley connected to the pivoting mechanism; and
a motor connected to the pulley and for driving the pulley to rotate the pivoting mechanism.

16. The electronic device of claim 10, wherein the sensing device is a light sensor or a proximity sensor.

17. The electronic device of claim 10, wherein the pivoting mechanism comprises a pivoting shaft, a first rib and a second rib, the first rib and the second rib protrude from the pivoting shaft and are spaced from each other, a connecting portion is formed between the first rib and the second rib, the driven component is a cam component, the cam component movably inserts into the connecting portion and selectively abuts against the first rib or the second rib, and the first rib pushes the driven component to move toward the first limiting position when the pivoting mechanism drives the image capturing device to rotate toward the first position along a first rotating direction.

18. The electronic device of claim 17, wherein the second rib pushes the driven component to move away from the first limiting position when the pivoting mechanism drives the image capturing device to rotate away from the first position along a second rotating direction opposite to the first rotating direction.
